(19) United States
(12) Patent Application Publication
(10) Pub. No.: US 2013/0325546 A1
(43) Pub. Date: Dec. 5, 2013

(54) PURCHASE BEHAVIOR ANALYSIS BASED ON VISUAL HISTORY

(71) Applicant: SHOPPER SCIENTIST, LLC, Corbett, OR (US)

(72) Inventor: Herb Sorensen, Corbett, OR (US)

(73) Assignee: Shopper Scientist, LLC, Corbett, OR (US)

(21) Appl. No.: 13/829,215

(22) Filed: Mar. 14, 2013

Related U.S. Application Data
(60) Provisional application No. 61/652,761, filed on May 29, 2012.

(51) Int. Cl. G06Q 30/02

(52) U.S. Cl. CPC G06Q 30/0201
USPC 705/7.29

(57) ABSTRACT

Methods for providing and comparing visual purchase deconstructions are provided. One example method for providing a visual purchase deconstruction includes recognizing a pre-purchase event, tracking movement of a focus position of one or both eyes of the shopper, recognizing a purchase event of the product, and, upon recognizing the purchase event, determining the purchase deconstruction representing the purchase based on the movement of the focus location during a pre-purchase window, the pre-purchase window having a duration from the pre-purchase event to the purchase event. The visual purchase deconstruction may be compared to one or more other purchases for any combination of products and shoppers. The visual purchase deconstruction and/or the comparisons thereof may be usable to determine one or more the factors that resulted in a product being purchased.

### CROSS REFERENCE TO RELATED APPLICATIONS

This application claims priority to U.S. Provisional Patent Application Ser. No. 61/652,761 filed May 29, 2012, entitled PURCHASE BEHAVIOR ANALYSIS BASED ON VISUAL HISTORY, the entire disclosure of which is herein incorporated by reference for all purposes.

### BACKGROUND

The retail business is extremely competitive. As such, retailers and manufacturers often desire to gather accurate and detailed information concerning purchases in order to more effectively market their goods, and thereby increase sales.

Over the past few years, shopper researchers have focused on the decision-making process performed by the shoppers when they shop, instead of merely focusing on the products that are ultimately purchased. Typical approaches involve conducting research online or in focus groups (e.g., via surveys, etc.), or in laboratory settings. However, such approaches remove the shopper from the actual shopping experience, and therefore do not provide an accurate, unbiased analysis of the shopping process. As such, a more unobtrusive and passive means for tracking a shopper may provide more accurate and expansive insight into the decision-making process.

For example, based on the fact that roughly 90% of the afferent nerve endings, i.e., those coming into the brain from the body, originate at the eyes, monitoring the eye (e.g., the point of focus) may provide a wealth of information regarding the activities of the brain. In other words, the inventor of the subject invention has realized that an intimate knowledge of the relation of the eye(s) to the purchases may provide the most immediate mechanism for analyzing the decision-making process, apart from potentially directly reading the mind through brainwaves, etc.

### SUMMARY

Methods for providing and comparing visual purchase deconstructions are provided. One example method for providing a visual purchase deconstruction includes recognizing a pre-purchase event, tracking movement of a focus position of one or both eyes of the shopper, recognizing a purchase event of the product, and, upon recognizing the purchase event, determining the purchase deconstruction representing the purchase based on the movement of the focus location during a pre-purchase window, the pre-purchase window having a duration from the pre-purchase event to the purchase event. The visual purchase deconstruction may be compared to one or more other purchases for any combination of products and shoppers.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE FIGURES

FIG. 1 shows a shopping scene including a progression of an eye focus position in relation to one or more products leading to a purchase.

FIG. 2 shows a process flow depicting an embodiment of a method for providing a visual purchase deconstruction.

FIG. 3 shows an embodiment of an example product map for providing visual purchase deconstruction.

FIG. 4 schematically shows an example representation of the pre-purchase window of the purchase of FIG. 1.

FIGS. 5-7 show example representations of information provided by visual purchase deconstruction.

FIG. 8 shows an example representation of information provided by visual trip deconstruction.

FIG. 9 shows an embodiment of an example use environment for providing visual purchase deconstruction.

### DETAILED DESCRIPTION

As mentioned above, the eyes provide the dominant input from the outside world to the brain. As such, by monitoring the temporal progression of the focus of the eyes, it may be possible to impute the factors (e.g., product packaging, advertisement, etc.), and the relationship therebetween, that resulted in a product being purchased. In other words, by treating the progression (e.g., order, duration, etc.) of eye focus position as interconnected, substantially continuous events, as opposed to independent events, richer analyses regarding the decision-making process employed by a shopper may be provided. The relative importance of such things as brand, price, etc., during the decision-making process itself may be determined, which may impact a wide-range of retailer and manufacturer activities, ranging from package design to in-store product placement. In other words, how shoppers make decisions (i.e., by what stimuli occur in what order, etc), may be monitored and deconstructed so that the purchasing decision becomes a stochastic process, and not simply a weighting of independent factors (e.g., what product was purchased). The visual analysis technique conceived of by the inventor, examples of which are presented herein, will be referred to as Visual Purchase Deconstruction “VPD.” VPD analyzes the events during the shopping process beginning when the shopper first “plants” or positions himself or herself at a location directly in front of where the purchase will occur (referred to herein as the “pre-purchase event”) and ending when the shopper moves merchandise from the display into the shopper's cart/basket/hand and moves on from the location (referred to herein as the “purchase event”). The time between, and including, the pre-purchase event and the purchase event constitutes what will be referred to herein as the “pre-purchase window.”

VPD utilizes the fleeting fixations of the eye (referred to herein as “eye focus events”), which may last for as little as tenths of a second. As such, a single purchase, even one lasting a few seconds, may comprise hundreds of eye focus events and associated object(s) of focus. Accordingly, manual monitoring of the purchase may be immensely time-consuming and labor-intensive, and are therefore not well-suited for the dynamic world of retail. For example, the analysis of hundreds of purchases (which may be necessary to establish informative trends) may require several months for a team of technicians to reduce the raw eye-tracking video, frame by frame, to a database suitable for analysis. Such manual measurement and input may further result in inaccurate analyses due to inherent human imprecision. The utilization of automated computer-vision techniques may therefore allow such visual purchase deconstruction to be accomplished in a relatively short amount of time, and may further allow for increased granularity and accuracy. Further, such techniques may allow for the establishment of complex trends via comparison(s) of multiple purchases.

It will therefore be appreciated that VPD may be usable to impute one or more factors important to the purchase decision-making process, and as such may be most useful when a purchase is actually made. In other words, the eye focus events may be afforded “meaning” when said events result in a purchase. As such, analysis of the eye focus events may be effected by recognizing the final point of focus (i.e., focus position at the purchase event) by operating on the assumption that whatever the eye was focused on at that point (e.g., logo, product picture, etc.) is the probable final trigger for the purchase. In other words, the final focus point may represent the feature(s) of the product that compelled the shopper to stop browsing and select a product. With this in mind, the further analysis via VPD may comprise determining the antecedent foci of the final focus, which may therefore allow inference regarding the antecedent steps of the decision-making process. These antecedent foci are related right back to the focus of the pre-purchase event when the shopper is addressing the shelf where the purchase ultimately occurs.

The outward expression (i.e., eye focus events while in front of the product display) of the purchase decision therefore describes at least the portion of the decision that occurs near the time of purchase, and said portion may provide the most useful information regarding the shopping process. Trends may thus be established by comparing multiple purchases, as will be discussed in greater detail below.

However, it will be appreciated that the purchasing decision may be at least partially formed before the shopper arrives at the shelf (e.g., reading of overhead aisle markers, etc.). Accordingly, further information regarding the shopping process may be determined by comparing the progression between multiple purchases (referred to herein as Visual Trip Deconstruction “VTD”).

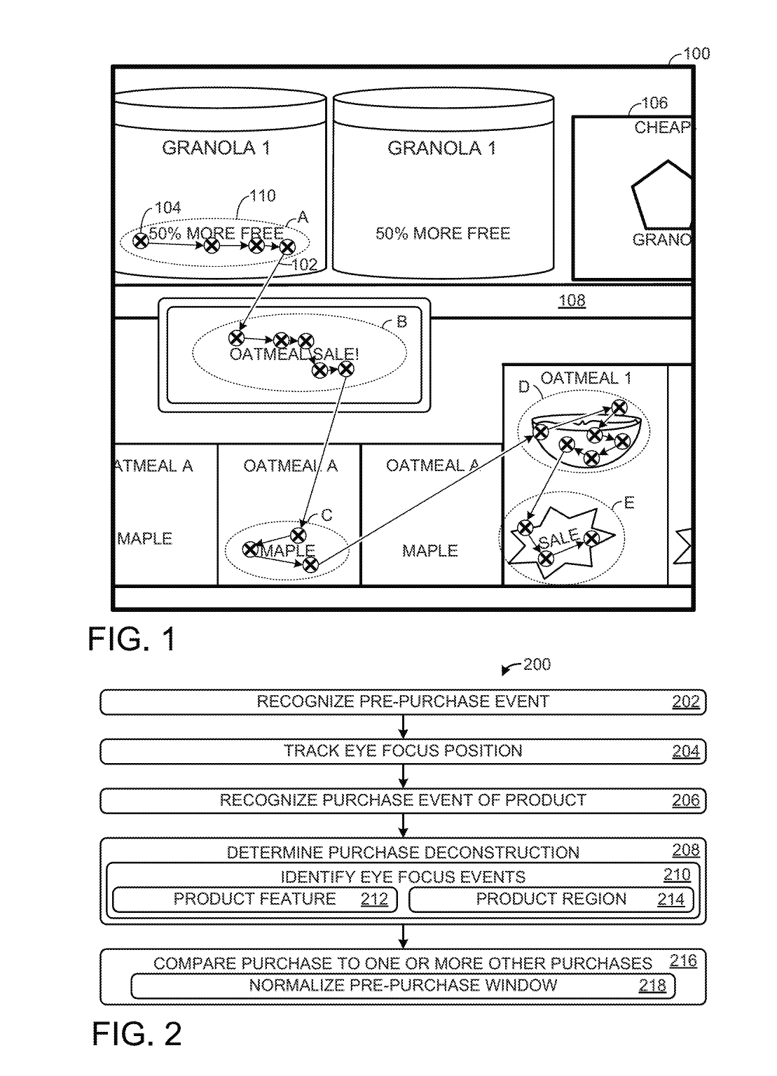

FIG. 1 shows a scene 100 of a shopping environment (e.g., supermarket) including a representation 102 of a temporal progression of an eye focus comprising a plurality of eye focus events 104 leading to a purchase. As illustrated, scene 100 comprises a plurality of products 106 (i.e., breakfast foods) arranged on shelves 108 in the shopping environment. It will appreciated that VPD is not limited to shelves in supermarkets, and may therefore be usable to analyze purchases of products located on any fixture or combination of fixtures (e.g., shelves, counters, bins, racks, etc.) in any suitable shopping environment (e.g., clothing retailer, department store, hardware store, bazaar, mall, etc.). As mentioned above and as will be discussed in greater detail below, each eye focus event 104 may be associated with a product feature 110. For the purpose of example, the features “A”, “B”, “C”, “D”, and “E”, refer to “50% more Free” of “Granola 1”, “Oatmeal Sale!” advertisement, “Maple” of “Oatmeal A”, product picture of “Oatmeal 1”, and “Sale” sticker of “Oatmeal 1”, respectively. It will be understood that FIG. 1 illustrates a purchase in simplified form for the ease of understanding, and that a purchase may include any number of eye focus events 104 (e.g., 100 or more) associated with any number of features 110. It will be further appreciated that a user's eyes may dart back and forth between different features 110 on the product, and thus the order of focus events (illustrated by representation 102) may indicate that features 110 are focused on multiple times during the purchase with one or more other features referenced in between.

FIG. 2 shows a process flow depicting an embodiment of a method 200 for providing a visual purchase deconstruction of a purchase of a product by a shopper (e.g., purchase depicted in FIG. 1). At 202, method 200 comprises recognizing a pre-purchase event. It will be appreciated that beginning the pre-purchase window at the pre-purchase event is useful in providing efficient deconstruction since it is at this point that the field of vision becomes relatively static as compared to the highly dynamic field of vision that occur during navigation (i.e., where the movement of the shopper dictates/follows the motion of the eyes, typically at 0-3 feet per second through the store). Such inter-purchase focus may therefore not allow for efficient and/or useful analysis of the decision-making process for an individual purchase. However, as mentioned above, such foci may be analyzed via VTD to determine the factor(s) important in moving shoppers from one purchase to another.

It will be appreciated that various events may be recognized as a pre-purchase event, depending on the implementation and/or the analysis desired. For example, in some embodiments, the pre-purchase event may be recognized as the first eye focus event associated with the product eventually purchased. For example, in the purchase of “Oatmeal 1” of FIG. 1, the first eye focus event 104 associated with a feature of “Oatmeal 1” is an eye focus event associated with feature D. In other embodiments, the pre-purchase event may be recognized as the first eye focus event in a predetermined spatial proximity to the purchase event, such as within the same shelf, or same product category area on a shelf (e.g., eye focus event of feature A of FIG. 1).

At 204, method 200 comprises tracking eye focus position. At 206, method 200 comprises recognizing the purchase event. In the depicted example purchase of FIG. 1, the eye focus position at the purchase event is illustrated as an eye focus event at feature E (i.e., “Sale” sticker of “Oatmeal 1”).

Upon recognizing the purchase event, method 200 comprises determining the purchase deconstruction at 208. Determining the purchase deconstruction may comprise identifying 210 one or more eye focus events (e.g., eye focus events 104 of FIG. 1). As mentioned above, it will be understood that a typical purchase may include any number of eye focus events and associated features occurring in any order (e.g., overlapping, etc.), and that the eye focus events depicted in FIG. 1 are presented for the purpose of simplicity of understanding. It will be further appreciated that rapid eye movement (i.e., saccade) without a discernable focus position may occur between eye focus events. Accordingly, in some embodiments, such saccades may be ignored by recognizing eye focus events as events comprising a substantially consistent eye focus position over a duration greater than or equal to a threshold duration (e.g., tenth of a second). Similarly, in other embodiments, although the eye focus events of FIG. 1 are represented by points, it will be appreciated that the eye focus position may vary during a given eye focus event. For example, in some embodiments, a grid may be used to analyze a given shopping scene (e.g., scene 100), and a distinct eye focus event may be recognized while the focus position remains within a single “block” on the grid.

In some embodiments, identifying the one or more eye focus events may further comprise identifying a product feature 212 associated with each of the one or more eye focus events. In some embodiments, specific features of the products and/or product packaging associated with each eye focus event may be categorized, or otherwise grouped. For example, categories of features associated with each focus event may include, but are not limited to, brand name/logo, product variety (e.g., “Maple” of feature C), description (e.g., size, product claims, product features, product type, etc. such as “50% more free” of feature A), product picture (e.g., bowl of oatmeal of feature D), price (which may be located independent of the product, such as on a shelf edge), and shelf features (e.g., shelf talkers, shelf ads such as “Oatmeal Sale!” of feature B, etc.).

It will be appreciated that product features may be identified through user input of predefined features, or by analyzing eye focus data to ascertain where eye focus events statistically cluster. For example, the eye focus events may be statistically analyzed to determine the regions in which such eye focus events cluster across a plurality of users viewing a single product, and those clusters may be imputed to define product feature regions. These clusters may be viewed by human operators and tagged with meta data indicating what they represent, such as “brand name,” “product description,” “iconic image,” etc.

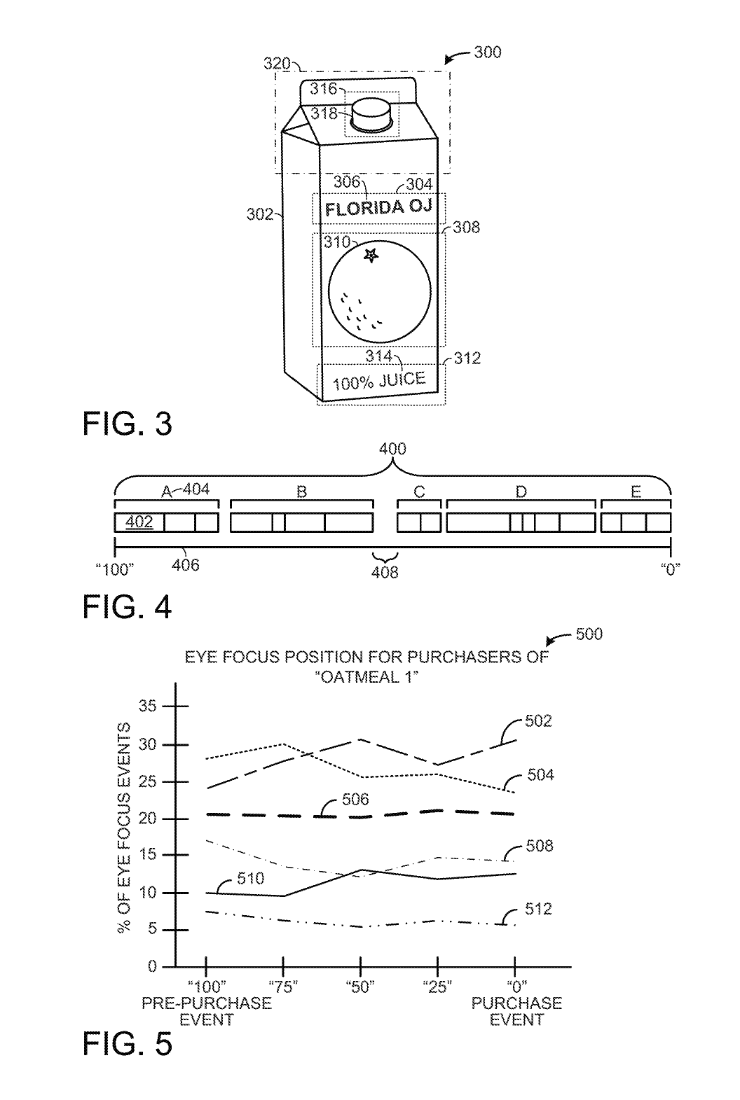

As another example, products may be assigned one or more pre-defined regions. For example, FIG. 3 shows an embodiment of an example product map 300 for product 302 (i.e., orange juice), which includes user defined regions around each of a plurality of product features. Product map 300 comprises region 304 associated with brand 306 (i.e., “Florida OJ”), region 308 associated with logo 310, region 312 associated with description 314 (i.e., “100% Juice”), and region 316 associated with variety 318 (i.e., twist-off cap). Accordingly, identifying the feature associated with each eye focus event for product 302 may comprise determining whether eye focus is directed towards region 304, 308, 312, or 316. Alternatively, the product regions may be predefined without an associated product feature, such as regions encompassing a top, bottom, front, or side of a product, or other area of the product, as desired. For example, as illustrated, region 320 may be associated with a top of product 320. Although the regions are depicted as comprising single rectangles, it will be appreciated that a region may comprise any suitable shape or combination of shapes arranged in any suitable configuration, and that one or more regions may at least partially overlap. It will be further appreciated that other mechanisms instead of, or in addition to, a product map may be utilized to identify product features.

Such information may be useful in determining the regions of the product most frequently referenced during the decision-making process, thereby providing insight as to where package features should be located. As such, in some embodiments, identifying the one or more eye focus events may further comprise identifying a product region 214 associated with each of the one or more eye focus events. It will be appreciated that these scenarios are presented for the purpose of example, and that VPD may be usable to visually deconstruct a purchase according to any suitable granularity without departing from the scope of the present disclosure.

As mentioned above, it may be more valuable to group purchases to assess what overall patterns move shoppers from first connection to the product to the final selection of the product for purchase. As such, method 200 comprises comparing the purchase to one or more other purchases at 216. As individual purchases may vary widely in duration, comparing the purchase may comprise normalizing 218 the pre-purchase window, and thus the eye focus events thereof.

It will be appreciated that method 200 may be accomplished via any suitable hardware or combination of hardware. For example, a shopper may possess a wearable computing device comprising one or more sensors configured to monitor the eye focus position of the user's eye(s). In other embodiments, one or more sensors configured to track eye focus position may be coupled to one or more products and/or to one or more product fixtures, and may be utilized instead of, or in addition to, a wearable computing device. Further, the order of the method steps presented above is merely exemplary, and those of skill in the art may appreciate that the steps may be performed in an alternative order. Finally, it should be understood that the data may be gathered by wearable devices, and analyzed on board or transmitted to an external computing device, such as a server, for analysis.

It will be even further appreciated that although the present disclosure is directed towards visual purchase deconstruction, one or more events of the pre-purchase window may be determined via use of other sensors in addition to eye focus sensors. For example, the occurrence of pre-purchase event and/or the purchase event may be detectable via proximity sensors, GPS, RFID, and/or any other sensor or combination of sensor capable of determining the position of the shopper and/or the product(s). It will be understood that these scenarios are presented for the purpose of example, and are not intended to be limiting in any manner.

Turning now to FIG. 4, an example normalized representation 400 of the pre-purchase window of the example purchase depicted in FIG. 1 is shown. Specifically, representation 400 illustrates the temporal progression (with time progressing from left to right) of the eye focus events 402, and the product features 404 associated therewith, on a normalized timeline 406. As depicted, the pre-purchase window may be normalized on a scale of “100” to “0”, with “100” representing the pre-purchase event and “0” representing the purchase event. Normalization may therefore allow for comparison of specific purchases and/or segments of purchases (e.g., last 10%, first 5%, etc.) spanning a wide range of durations. The illustrated normalization is presented for the purpose of example, and that any mechanism or combination of mechanisms for comparing a plurality of purchases may be utilized without departing from the scope of the present disclosure. Further, although many of focus events 402 are illustrated as occurring sequentially without interruption, the pre-purchase window may include one or more periods of time (represented by gap 408) where no eye focus event occurs (e.g., during a saccade, or “sweeping” eye movement from one product to another). Although such periods are illustrated as occurring during movement from one product feature 404 to another, it will be appreciated these may occur between any eye focus events 402, as mentioned above. Such periods of time may be ignored in some embodiments, while in other embodiments such information may be usable to provide greater insight into the decision-making process.

The rich dataset provided by eye focus tracking may be usable to determine various trends exhibited through multiple purchases of a given product and/or across multiple products via comparisons of two or more purchases. As such, FIGS. 5-7 show example representations of information provided by visual purchase deconstruction of, for example, multiple purchases by a single shopper, multiple purchases each by a different shopper, and/or a combination thereof. Representation 500 of FIG. 5 illustrates the time-based deconstruction of a plurality of purchases of “Oatmeal 1” (e.g., purchase depicted in FIG. 1) by depicting time-varying percentages of eye focus events for various product features during the pre-purchase window. Specifically, product picture (e.g., feature D of FIG. 1), brand, description (e.g., feature A of FIG. 1), price, variety (e.g., feature C of FIG. 1), and miscellaneous features (e.g., packaging “white space”, saccades, etc.) are represented via percentages 502, 504, 506, 508, 510, and 512, respectively. Representation 500 illustrates that brand, represented by percentage 504, is the feature with the largest percentage of focus events for roughly the first 20% of the purchase window, and further illustrates that that product picture, represented by percentage 502 is the dominant feature for roughly the final 80% of the pre-purchase window. Representation 500 yet further illustrates that price, represented by percentage 510, comprises roughly 15% of the eye focus events throughout the pre-purchase window, which is roughly half the percentage of product image and brand.

Representation 500 therefore illustrates that brand may be the first feature that is focused on, but that product picture plays a far more prominent role in the purchase decision throughout the remainder of the pre-purchase window. As such, this information may compel the manufacturer to devote a larger percentage of the product packaging to the product image, while still ensuring that the brand initially grabs a shopper's attention. Further, a retailer may use this information to determine that a price increase and/or a decrease in discount frequency may not substantially impact product sales, and may therefore increase profit.

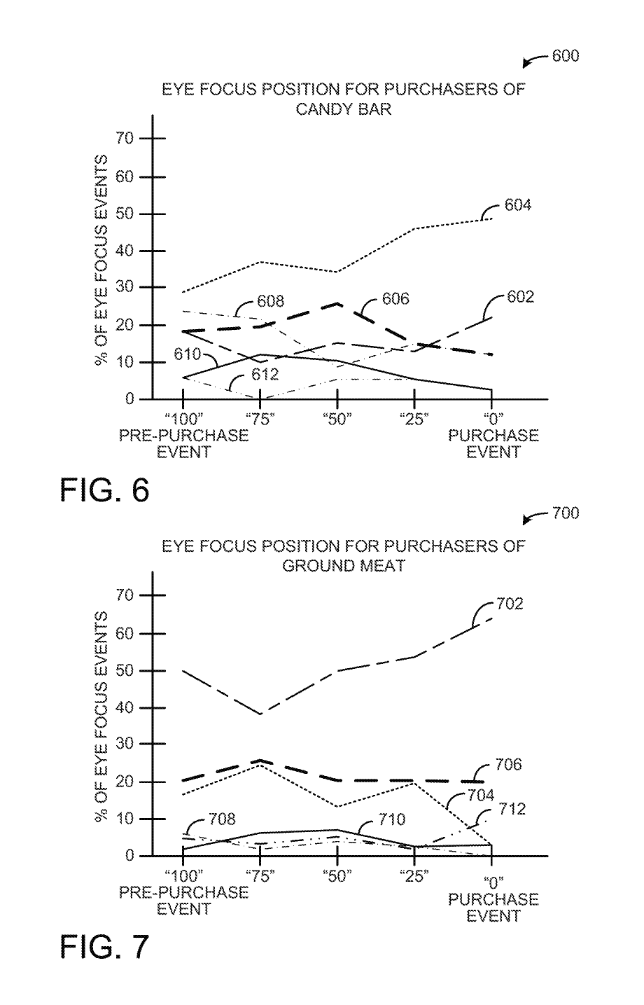

It will be appreciated that the feature(s) important to a purchase decision may vary across products or product categories. Accordingly, FIGS. 6 and 7 show example representations of information provided by visual purchase deconstruction of purchases of a candy bar and ground meat, respectively. Remaining visually consistent with representation 500 of FIG. 5, FIGS. 6 and 7 comprise time-varying percentages of eye focus events associated with product picture 602 and 702, brand 604 and 704, description 606 and 706, price 608 and 708, variety 610 and 710, and miscellaneous features 612 and 712.

As illustrated by representation 600, brand 604 is consistently the driving factor in the purchase of a candy bar. From this information, a candy bar manufacturer may determine that a majority of the product packaging should be devoted to the brand name.

Further, price 608 commands its maximum percentage of eye focus events in the middle of the pre-purchase window, and product picture 602, which is typically small or non-existent due to the size of candy bar wrappers, commands roughly 20% of the eye focus events at the pre-purchase event and the purchase event (i.e., the second highest share at the purchase event). As such, the manufacturer may determine that, since product picture is referenced frequently at both the beginning and the end of the pre-purchase window, product picture may act as both a “hook” to begin the purchase process and as the deciding factor in ultimately effecting the purchase. Therefore, greater resources may be directed towards the design of a more effective product picture.

In comparison, as illustrated by representation 700 of FIG. 7, product picture 702 (e.g., see-through view of actual ground meat product) commands over 50% of the eye focus share for a majority of the pre-purchase window. Brand 704 and description 706 command roughly 15%-25% of the eye focus events throughout most of the pre-purchase window, with brand 704 becoming essentially a non-factor for the last 25%. As such, a manufacturer of ground meat may devote a majority of the packaging to product image, while ensuring that the brand is sufficiently attention-grabbing to be noticed in the first half of the pre-purchase window. Further, a retailer may determine that a price increase may not affect sales since price 708 comprises a substantially negligible share of the eye focus events and said share remains substantially consistent throughout the pre-purchase window.

It will be appreciated that any type and combination of analyses may be provided by the VPD technique described herein. It will be further appreciated that, as mentioned above, the categories of product features depicted in FIGS. 5-7 are presented for the purpose of example, and that the eye focus events may be grouped and analyzed according to any granularity without departing from the scope of the present disclosure.

As described above, the analysis provided by VPD (e.g., order and duration of interconnected events) may be usable to analyze the interconnected events between purchases via VTD. In other words, a shopping trip may comprise multiple discrete purchases separated in time, and the eye focus events between said purchases may provide greater insight into the shopping process. As such, any combination of the above described analyses that may be used to analyze the progression of a single purchase may be usable to analyze the progression between purchases. In other words, analysis of the progression of eye focus events as the shopper moves around the store may be usable to analyze the overall shopping process, which may be represented as a series of purchases, each having its own pre-purchase events. This information may be usable to adjusting a wide variety of features of the shopping experience, such as store layout, display types, packaging design, etc.

Accordingly, the inter-purchase duration (i.e., “inter-purchase window) may be normalized similar to the VPD normalization described above, such that multiple datasets may be compared. However, In contrast to the substantially fixed scene of VPD (e.g., scene 100 of FIG. 1) described above, it will be appreciated that VTD comprises the analysis of a dynamic scene that may change substantially at least every few seconds during the navigation. As such, in some embodiments, eye focus events for VTD may be determined differently than for VPD (e.g., different categories, different temporal thresholds, etc.).

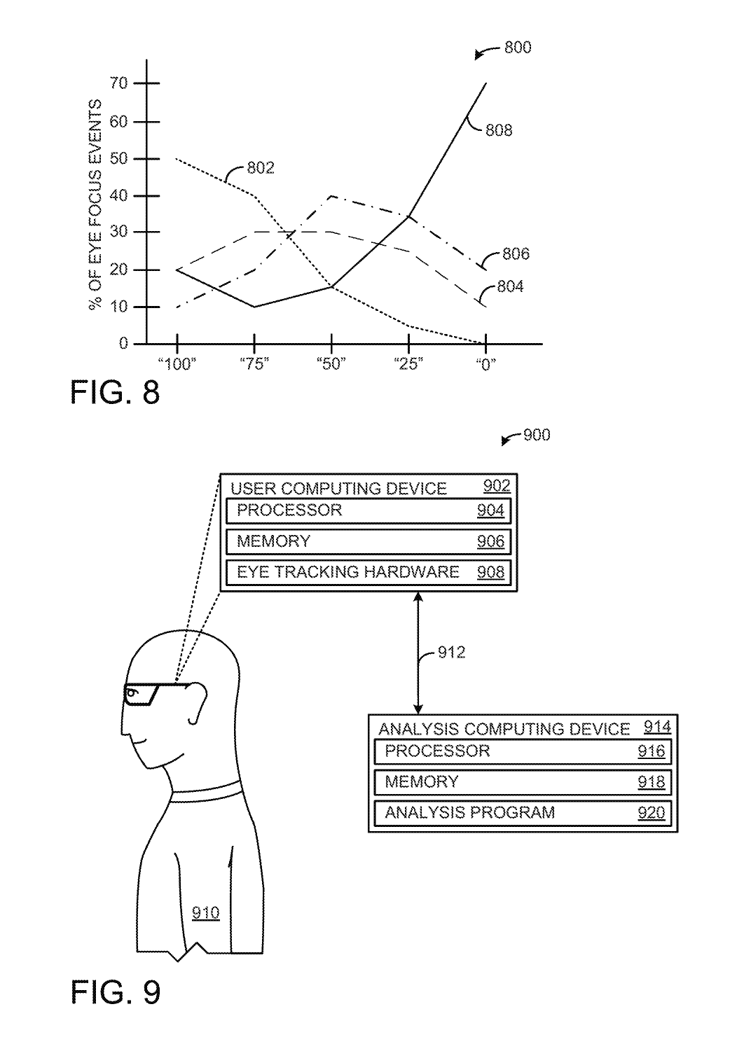

For example, FIG. 8 shows a representation 800 of information provided by VTD comprising eye focus events related to aisle (e.g., aisle ID) 802, category 804 (e.g., condiments, cereal, etc.), sub-category 806 (e.g., ketchup, oatmeal, etc.), and brand 808. Similar to the representations of VPD, representation 800 is presented on a normalized timeline from “100” (i.e., end of previous purchase) to “0” (pre-purchase event of next purchase) representing the time between purchases (i.e., inter-purchase window). In this way, representation 800 provides information on how a user finds a product and/or browses a shopping environment. For example, as illustrated, brand 808 comprises the majority of eye focus events for the last 25% of the inter-purchase window, and therefore a manufacturer and/or retailer may determine that a recognizable brand may effect a pre-purchase event (i.e., causing a shopper to stop navigating and begin browsing). Further, as sub-category 806 becomes the dominant factor in the middle of the inter-purchase window, it may be determined that such features lead to the browsing of brands, and thus sub-category 806 may be recognized as the common “antecedent focus” for brand 808. As with VPD, it will be appreciated that the eye focus event categories of VTD are presented for the purpose of example, and that any suitable granularity may be utilized without departing from the scope of the present disclosure.

FIG. 9 shows an embodiment of an example use environment 900 for providing visual purchase deconstruction and visual trip deconstruction. User computing device 902(e.g., eyeglasses-type device) comprises a processor 904, memory 906, and eye tracking hardware 908 (e.g., one or more imaging sensors) in order to monitor the focus position of one or both of eyes of user 910. User computing device 902 may further communicate, via communication link 912, with analysis computing device 914 comprising processor 916, memory 918. Analysis computing device 914 may be configured to execute, via processor 916, analysis program 920 to provide visual purchase deconstruction based on output from eye tracking hardware 908. In other embodiments, analysis program 920 may be at least partially executed by user device 902. Although communication link 912 is schematically illustrated as a direct connection between user device 902 and analysis device 914, it will be appreciated that said communication link may comprise one or more networks and/or one or more subnetworks, and that said communication link may comprise any combination of wired and/or wireless connections. Further, although a single user computing device is illustrated, it will be appreciated that a plurality of user devices may communicate with analysis computing device 914 in order to provide visual purchase deconstruction based on the purchases of multiple users.

It will be appreciated that the use environment of FIG. 9 is presented for the purpose of example, and that the methods described herein may be performed via any suitable computing device or combination of computing devices. Generally speaking, the computing devices may be mainframe computers, personal computers, laptop computers, portable data assistants (PDAs), mobile telephones, networked computing devices, or other suitable computing devices. These devices may be connected to each other via computer networks, such as the Internet. These computing devices typically include a processor and associated volatile and non-volatile memory, and are configured to execute programs stored in non-volatile memory using portions of volatile memory and the processor. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

1. A method for providing a purchase deconstruction of a purchase of a product by a shopper, the method comprising:
recognizing a pre-purchase event;
tracking movement of a focus position of one or both eyes of the shopper;
recognizing a purchase event of the product; and
upon recognizing the purchase event, determining the purchase deconstruction representing the purchase based on the movement of the focus location during a pre-purchase window, the pre-purchase window having a duration from the pre-purchase event to the purchase event.

2. The method of claim 1, wherein determining the purchase deconstruction comprises identifying one or more eye focus events, wherein the purchase deconstruction represents an order, a duration, and a location of the one or more eye focus events.

3. The method of claim 2, wherein identifying the one or more eye focus events comprises recognizing the focus position as being substantially stationary for at least a threshold duration.

4. The method of claim 2, wherein identifying the one or more eye focus positions comprises identifying a product features associated with each of the one or more eye focus events, the product feature comprising one of brand name, logo, product variety, description, product picture, and shelf feature.

5. The method of claim 2, wherein identifying the one or more eye focus events comprises identifying a product region associated with each of the one or more eye focus events.

6. The method of claim 1, further comprising comparing the purchase deconstruction to one or more other purchase deconstructions representing one or more other purchases.

7. The method of claim 6, wherein the one or more other purchases are purchases of the product.

8. The method of claim 6, wherein the one or more other purchases are purchases of a different product.

9. The method of claim 6, wherein comparing the purchase deconstruction comprises normalizing the duration of the pre-purchase window of the purchase and normalizing a duration of a pre-purchase window of each the one or more other purchases.

10. The method of claim 1, wherein tracking movement of the focus position comprises analyzing image data received from one or more image sensors worn by the shopper.

11. The method of claim 1, wherein tracking movement of the focus location comprises analyzing image data received from one or more image sensors independent of the shopper.

12. A method for analyzing two or more purchases, the method comprising:
for each purchase,
recognizing a pre-purchase event,
tracking movement of a focus position of one or both eyes of a shopper by analyzing image data received from one or more image sensors,
recognizing a purchase event of the product, and
upon recognizing the purchase event, determining the purchase deconstruction representing the purchase based on the movement of the focus location during a pre-purchase window by identifying one or more eye focus events, the pre-purchase window having a duration from the pre-purchase event to the purchase event, identifying the one or more eye focus events comprising identifying a product features associated with each eye focus event and identifying a product region associated with each eye focus event,
wherein the purchase deconstruction represents an order, a duration, and a location of the one or more eye focus events; and
comparing the purchase deconstructions of the two or more purchases by normalizing the duration of the pre-purchase window of each of the purchases.
